(19) United States
(12) Patent Application Publication
(10) Pub. No.: US 2016/0191436 A1
(43) Pub. Date: Jun. 30, 2016

(54) ELECTRONIC DEVICE AND METHOD FOR FILTERING MESSAGES

(71) Applicant: FIH (HONG KONG) LIMITED, Kowloon (HK)

(72) Inventor: YU-YING YU, New Taipei (TW)

(21) Appl. No.: 14/830,918

(22) Filed: Aug. 20, 2015

(30) Foreign Application Priority Data
Dec. 30, 2014 (TW) 103146314

(51) Int. Cl. H04L 12/58; G06F 17/24; G06F 3/0484; H04L 29/06

(52) U.S. Cl. CPC H04L 51/12; H04L 67/42; G06F 17/248; G06F 3/04842

(57) ABSTRACT

In a method for filtering messages being executed by at least one processor of electronic devices, the method includes detecting a message filtering template set by the first electronic device when the first electronic logs into the server successfully; sends a content of the message filtering template and a communication request from the first electronic device to the server; sends the content to the second electronic device by the server, the content of the message filtering template including functions of stop receiving messages from group members within a first certain period of time or refusing to send messages to one or more group members within a second certain period of time; and receiving a selection from the second electronic device through the server.

### CROSS-REFERENCE TO RELATED APPLICATIONS

This application claims priority to Taiwanese Patent Application No. 103146314 filed on Dec. 30, 2014, the contents of which are incorporated by reference herein.

### FIELD

The subject matter herein generally relates to communication technology, and particularly to an electronic device and method for filtering messages.

### BACKGROUND

Communication software (for example, QQ) installed on an electronic device can enable users to communicate with others connected to the Internet conveniently. Electronic devices can be configured to exchange data with other devices. The electronic devices can exchange data with a closely situated device using different radio communications, for example, short distance or cellular based communications. Additionally, electronic devices can execute applications which would allow the electronic devices to communicate over a network or the Internet.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of a communication between two electronic devices.

FIG. 2 is a block diagram of an example embodiment of a first electronic device.

FIG. 3 is a block diagram of an example embodiment of a second electronic device.

FIG. 4 illustrates a flowchart of an example embodiment of a method for filtering messages in the first electronic device.

FIG. 5 illustrates a diagrammatic view of an example embodiment of a message filtering template.

FIG. 6 illustrates a flowchart of an example embodiment of a method for filtering messages in the second electronic device.

FIG. 7 is a diagrammatic view of a first example embodiment of a user interface of a selection.

FIG. 8 is a diagrammatic view of a second example embodiment of a user interface of a selection.

FIG. 9 is a diagrammatic view of an example embodiment of receiving messages.

FIG. 10 is a diagrammatic view of an example embodiment of sending messages.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series and the like.

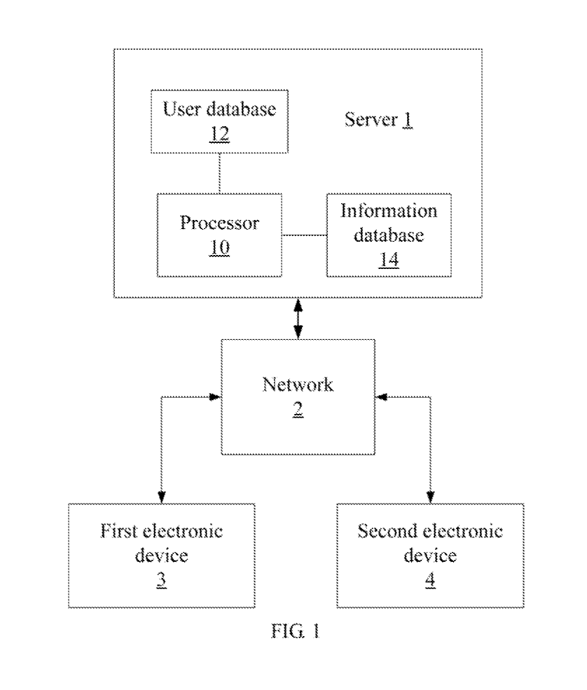

FIG. 1 is a block diagram of an example embodiment of a communication between two electronic devices. In at least one embodiment as shown in FIG. 1, electronic devices can include a first electronic device 3 and a second electronic device 4. The first electronic device 3 can send messages, and the second electronic device 4 can receive messages, or vice versa.

In at least one embodiment, the first electronic device 3 can establish communication with the second electronic device 4 and a server 1 via a network 2. In at least one embodiment, the communication connection can be a wired connection, or a wireless connection. The network 2 can be a mobile communication network, a public telephone network, Internet, a local area network (LAN), or any other applicable network.

In at least one embodiment, the server 1 can provide plurality of communication services for the first electronic device 3 and the second electronic device 4. The server 1 can be a switch, a router, or a service center network. When the message is finished being edited on the first electronic device 3 (the sender), the message can be sent to the second electronic devices 4 (the receiver) via the server 1.

In at least one embodiment, the server 1 includes, but is not limited to, at least one processor 10, a user database 12, and an information database 14. The user database 12 can store user login information of each electronic device. The user login information of each electronic device can include an Internet Protocol (IP) address, a user name, a login point or an access point connected to the network 2.

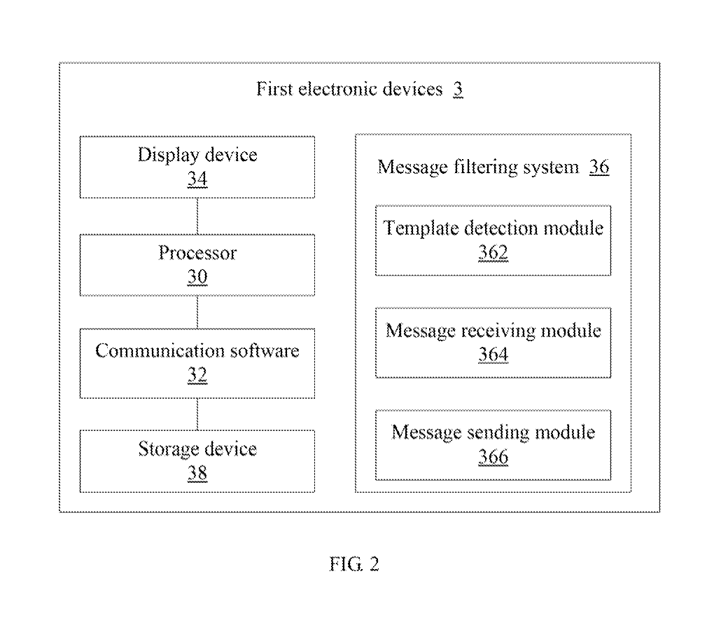

FIG. 2 is a block diagram of an example embodiment of the first electronic device. In at least one embodiment as shown in FIG. 2, the first electronic device 3 includes, but is not limited to, at least one processor 30, a communication software 32, a display device 34, a message filtering system 36, and a storage device 38. The first electronic device 3 can be a mobile phone, a tablet computer, a personal digital assistant, or any other electronic device having communication software 32. FIG. 1 illustrates only one example of the electronic device, other examples can include more or fewer components than illustrated, or have a different configuration of the various components in other embodiments.

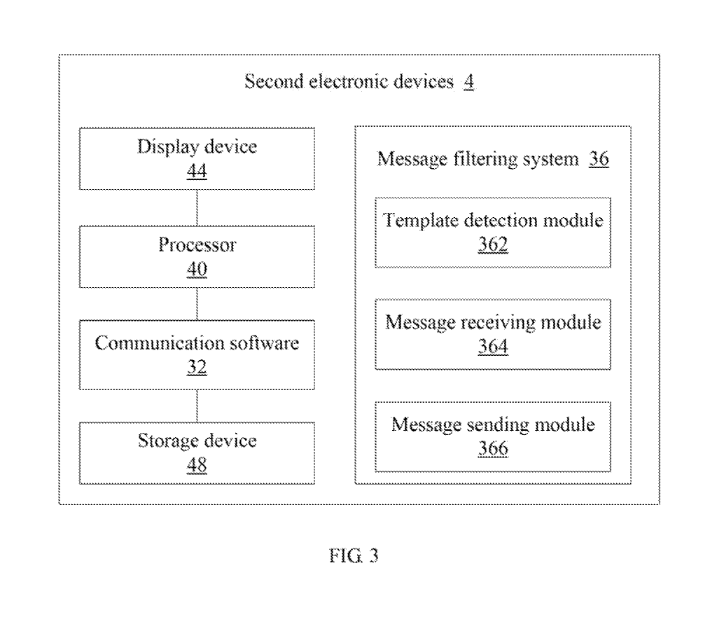

FIG. 3 is a block diagram of an example embodiment of the second electronic device. In at least one embodiment as shown in FIG. 3, the second electronic device 4 includes, but is not limited to, at least one processor 40, a communication software 32, a display device 44, a message filtering system 36, and a storage device 48. In at least one embodiment, the processors 30, 40 can be a central processing unit (CPU), a microprocessor, or other data processor chip that performs functions of the electronic device (the first electronic device 3 and the second electronic device 4). The processors 30, 40 can perform a function of filtering messages, for example, stop receiving messages or refuse to send messages within a certain period of time.

In at least one embodiment, the communication software 32 can be common software applications installed in the electronic device. The communication software 32 can include QQ, Micro Blog, WeChat, or any other instant messaging system.

In at least one embodiment, the display devices 34, 44 can provide a human-computer interaction interface, which can display different kinds of applications interfaces (e.g., a lock screen interface, a main menu and various functions interface), and can receive operational commands input by a user. The display devices 34, 44 can be a touch panel, which supports multi-touch, such as resistive touch screens or capacitive touch screens.

In at least one embodiment, the storage devices 38, 48 can include various types of non-transitory computer-readable storage mediums. For example, the storage devices 38, 48 can be an internal storage system, such as a flash memory, a random access memory (RAM) for temporary storage of messages, and/or a read-only memory (ROM) for permanent storage of messages. The storage devices 38, 48 can also be an external storage system, such as a hard disk, a storage card, or a data storage medium.

In at least one embodiment, the message filtering system 36 can include a template detection module 362, a message receiving module 364, and a message sending module 366. The function modules 362, 364, and 366 can include computerized codes in the form of one or more programs which are stored in the storage device. The processors 30 and 40 of the first electronic device 3 and the second electronic device 4 execute the computerized codes to provide functions of the function modules 362-364.

The template detection module 362 can detect a message filtering template set by the first electronic device 3 (the sender), then send the content of the message filtering template and a communication request of the first electronic device 3 to the server 1. In some embodiments, the communication request can be that the first electronic device 3 inviting members in the communication group to establish a communication connection. The content of the message filtering template can be functions for filtering messages.

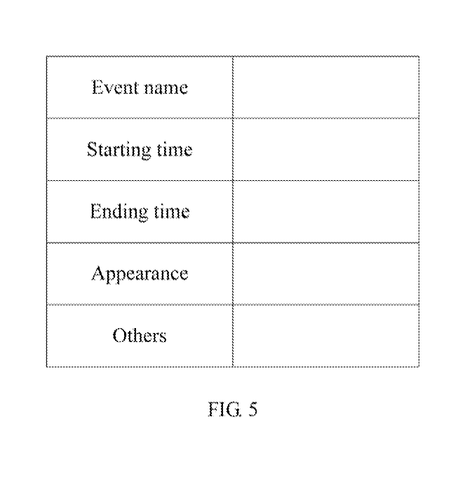

FIG. 5 illustrates that the message filtering template can be installed on the electronic device, and the message filtering template can provide message filtering functions for users to set. For example, the users can set a function to stop receiving messages from group members within a first certain period of time (e.g. two weeks), or refuse to send messages to one or more group members within a second certain period of time (e.g. one day).

In at least one embodiment, the content of the message filtering template can have the following several parts: an event name, a starting time, an ending time, appearance, or others. The event name can be defined as a name of performing the function for filtering messages. The starting time can be defined as a time of starting to perform the message filtering functions. The ending time can be defined as a time of ending to perform the message filtering functions. The appearance can be defined as whether the group messages appear or not after performing the message filtering functions. When the user sets the appearance to “Y”, it indicates that the group messages will appear on the display device 44 of the second electronic device 4 (the receiver). When the user sets the appearance to “N”, it indicates that the group messages will not appear on the display device 44 of the second electronic device 4 (the receiver).

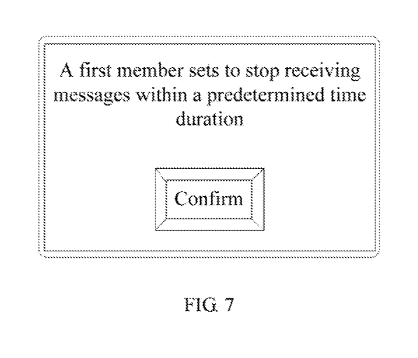

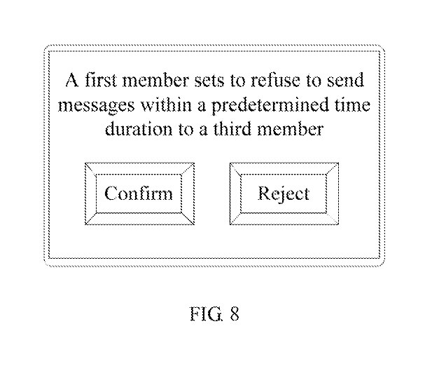

The message receiving module 364 can receive contents of the message filtering template, after the first electronic device 3 (the sender) performs the function for filtering messages, and displays an interface of a selection on the display device 44 of the second electronic device 4. The interface of a selection can be displayed in a form of a dialog box, or in any other suitable way. There are two types of dialog boxes, responding to the content of the message filtering template, as shown in FIG. 7 and in FIG. 8. FIG. 7 is a diagrammatic view of an example embodiment of performing a function to stop receiving messages. For example, the display device 44 of the second electronic device 4 (the receiver) can display a dialog box including contents of “A first member has set to stop receiving messages within a predetermined time duration,” “Confirm”. FIG. 8 is a diagrammatic view of an example embodiment of performing a function of refusing to send messages. For example, the display device 44 of the second electronic device 4 (the receiver) can display a dialog box including contents of “A first member has set to refuse to send messages to a third member within predetermined time duration,” “Confirm,” “Reject”.

The message receiving module 364 can also receive a selection made by the second electronic device 4 (the receiver) from the server 1. The selection can be “Confirm” or “Reject” made by the second electronic device 4.

The message sending module 366 can send the selection made by the second electronic device 4 (the receiver) to the first electronic device 3 (the sender) through the server 1. The selection can be “Confirm” or “Reject” made by the second electronic device 4.

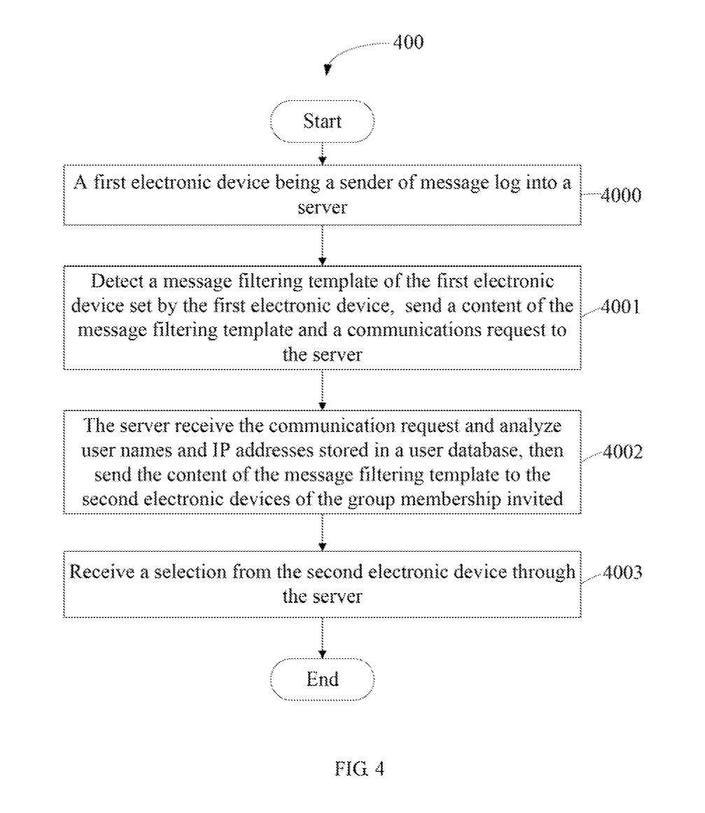

FIG. 4 illustrates a flowchart in accordance with an example embodiment. An example method 400 is provided by way of example, as there are a variety of ways to carry out the method. The example method 400 described below can be carried out using the configurations illustrated in FIG. 2, and various elements of these figures are referenced in explaining the example method. Each block shown in FIG. 400 represent one or more processes, methods, or subroutines carried out in the example method 400. Furthermore, the illustrated order of blocks is illustrative only and the order of the blocks can be changed. The example method 400 can begin at block 4000. Depending on the embodiment, additional blocks can be utilized and the ordering of the blocks can be changed.

At block 4000, a first electronic device being a sender logs into a server successfully.

At block 4001, a template detection module of the first electronic device detects a message filtering template set by the first electronic device, then, sends content of the message filtering template and a communication request to the server. In some embodiments, the communication requests can be that the first electronic device invites members in the communication group to establish a communication connection. The content of the message filtering template can be functions for filtering messages.

In at least one embodiment, the content of the message filtering template can have the following parts: an event name of performing the function for filtering messages, a starting time of performing the function for filtering messages, an ending time of performing the function for filtering messages, whether the group messages appear or not after performing the function for filtering messages. When the user selects “Y”, it indicates that the group messages will be displayed on the display device of the second electronic device. When the user sets “N”, it indicates that the group messages will not be displayed on the display device 44 of the second electronic device.

At block 4002, the server receives the communication request and analyzes user names and IP addresses stored in a user database, and then sends the content of the message filtering template to the second electronic device of the invited group members.

At block 4003, a message receive module of the first electronic device receives a selection from a second electronic device (the receiver) through the server. The selection can be “Confirm” or “Reject”.

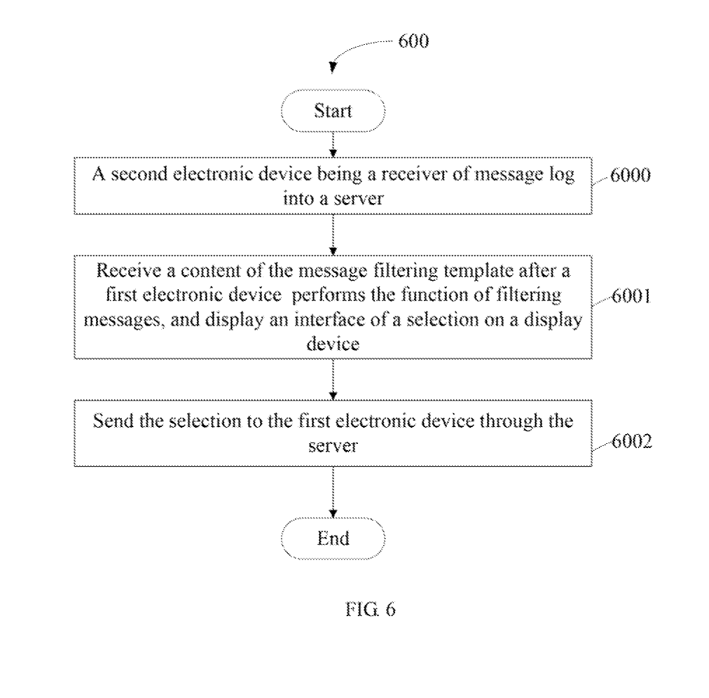

FIG. 6 illustrates a flowchart in accordance with an example embodiment. An example method 600 is provided by way of example, as there are a variety of ways to carry out the method. The example method 600 described below can be carried out using the configurations illustrated in FIG. 3, and various elements of these figures are referenced in explaining the example method. Each block shown in FIG. 600 represent one or more processes, methods, or subroutines carried out in the example method 600. Furthermore, the illustrated order of blocks is illustrative only and the order of the blocks can be changed. The example method 600 can begin at block 6000. Depending on the embodiment, additional blocks can be utilized and the ordering of the blocks can be changed.

At block 6000, a second electronic device being a receiver logs into a server successfully.

At block 6001, the second electronic device receives the content of the message filtering template via a message receiving module of the second electronic device, after a first electronic device (the sender) performs the function for filtering messages, and displays an interface of a selection on a display device of the second electronic device.

The interface of selecting module can be displayed in a form of a dialog box, or in any other suitable way. There are two types of dialog boxes, responding to the content of the message filtering template, as shown in FIG. 7 and in FIG. 8. Wherein, FIG. 7 is a diagrammatic view of an example embodiment of performing a function of stop receiving messages. For example, the display device of the second electronic device can display a dialog box: “a first member is set to stop receiving messages within a certain period of time,” “Confirm”. FIG. 8 is a diagrammatic view of an example embodiment of performing a function to refuse to send messages. For example, the display device of the second electronic device can display a dialog box: “a first member is set to refuse to send messages to a third member within predetermined time duration, “Reject”.

At block 6002, after the second electronic device makes a selection, a message sending module of the second electronic device sends the selection to the first electronic device through the server. The selection can be “Confirm” or “Reject”.

The following are two application implementations using the method of performing functions of filtering messages.

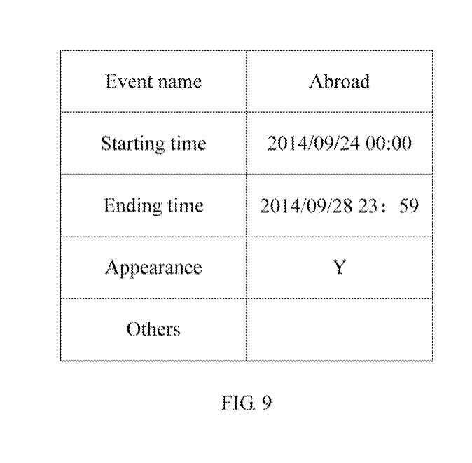

A first application implementation, as shown in FIG. 9, using the method of message filtering to perform a function to stop receiving message from group members. The first electronic device can be a smart phone, the communication software 32 is QQ, an event name is “Abroad”, the group members include a first member, a second member, a third member and so on. The total number of the group members is thirty.

When QQ is installed on the smart phone of the first member and is successfully logged on to a server. The first member sets the message filtering template, an event name: “Abroad”, a starting time: 2014/09/24 00:00, an ending time: 2014/09/28 23:59, and appearance: “Y”. The smart phone of the first member detects the content of the message filtering template set by the user, and then sends the content to all thirty members (including the first member). The smart phones of all thirty members receive the content and display a dialog box “The first member has set to stop receiving messages between 2014/09/24 00:00 and 2014/09/28 23:59, Confirm”. After twenty-nine members make selections of “Confirm”, the smart phones of the twenty-nine members send the selections of “Confirm” to the first member. The first member will not receive messages from the other members of the “class group” between 2014/09/24 00:00 and 2014/09/28 23:59. After 2014/09/28 23:59, messages from other members of the “class group” will be displayed in a chat window of QQ. If the first member sets the appearance to: “N”, after 2014/09/28 23:59, messages from other members of the “class group” will not be displayed in the chat window of QQ of the first member.

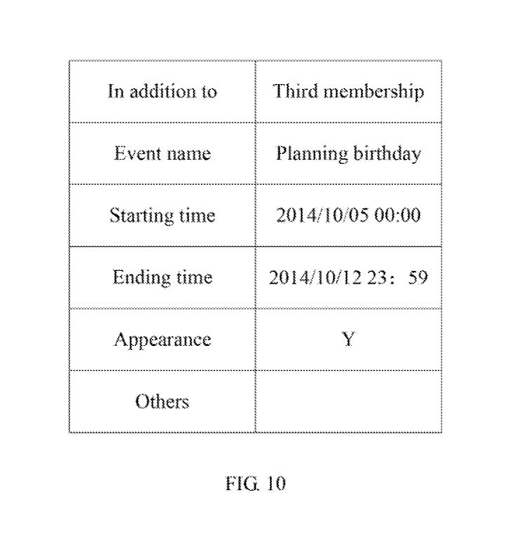

A second application implementation is shown in FIG. 10, when using the method of filtering messages to perform a function of refusing to send messages to group members. In this embodiment, the first electronic device can be a smart phone, the communication software is QQ, an event name is “Class group”, the group members include a first member, a second member, a third member to a total of thirty group members.

QQ installed on the smart phone of the first member successfully logs into a server. The first member sets the message filtering template, an event name: Planning a birthday for the third member, a starting time: 2014/10/05 00:00, an ending time: 2014/10/12 23:59, and appearance: “Y”. The smart phone of the first member detects the content of the message filtering template set by the user, then sends the content to the twenty-eight members (including the first member itself and the third member), or the members of the “class group” which is designated by the first member. The smart phones of the twenty-eight members or the designated members receive the content and display a dialog box “the first member takes action to refuse to send messages to the third member, between 2014/10/05 00:00 and 2014/10/12 23:59,” “Confirm,” “Reject”. After the twenty-eight members or the designated members make selections of “Confirm” or “Reject”, the smart phones of the twenty-eight members or the designated members send the selections of “Confirm” or “Reject” to the first member. The third member will not receive messages from others of the “class group” or the designated members between 2014/10/05 00:00 and 2014/10/12 23:59. After 2014/10/12 23:59, messages from others of the “class group” or the designated members will be displayed in a chat window of QQ. If the first member sets the appearance to: “N”, after 2014/10/12 23:59, messages from others of the “class group” will not be displayed in the chat window of QQ of the third member.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for filtering messages being executed by at least one processor of electronic devices, the electronic devices comprising a first electronic device which is a sender of message and a second electronic device which is a receiver of message, the first electronic device communicating with the second electronic device via a server, the method comprising:
detecting a message filtering template set by the first electronic device when the first electronic logs into the server successfully;
sending a content of the message filtering template and a communication request from the first electronic device to the server;
sending the content to the second electronic device by the server, the content of the message filtering template comprising functions to stop receiving messages from group members within a first certain period of time or refuse to send messages to one or more group members within a second certain period of time; and
receiving a selection from the second electronic device through the server.

2. The method according to claim 1, wherein the message filtering template comprises an event name of performing the function for filtering messages, a starting time of performing the function for filtering messages, an ending time of performing the function for filtering messages, whether the group messages appear or not after performing the function for filtering messages.

3. The method according to claim 2, wherein when the function of filtering messages is set to stop receiving messages, the selection comprises “Confirm”; and when the function of filtering messages is set to refuse to send messages, the selection comprises “Confirm” or “Reject”.

4. The method according to claim 1, before the second electronic device making a selection, further comprising:
receiving the content of the message filtering template, after the first electronic device performing the function for filtering messages;
displaying an interface of a selection on a display device of the second electronic device; and
sending a selection made by the second electronic device to the first electronic device through the server.

5. An electronic device being a sender of message, communicating with a second electronic device which is a receiver of message via a server, comprising:
a display device;
at least one processor coupled to the display device; and
a storage device coupled to the at least one processor and storing one or more programs executable by the at least one processor to cause the at least one processor to:
detect a message filtering template set by the electronic device when the electronic device logs into the server successfully;
send a content of the message filtering template and a communications request from the electronic device to the server, the server sends the content to the second electronic device, the content of the message filtering template comprising functions to stop receiving messages from group members within a first certain period of time or refuse to send messages to one or more group members within a second certain period of time; and
receive a selection from the second electronic device through the server.

6. The electronic device according to claim 5, wherein the message filtering template comprises an event name of performing the function for filtering messages, a starting time of performing the function for filtering messages, an ending time of performing the function for filtering messages, whether the group messages appearing or not after performing the function for filtering messages.

7. The electronic device according to claim 6, wherein when the function of filtering messages is set to stop receiving messages, the selection comprises “Confirm”; and when the function of filtering messages is set to refuse to send messages, the selection comprises “Confirm” or “Reject”.

8. An electronic device being a receiver of message, communicating with a first electronic device which is a sender of message via a server, comprising:
a display device;
at least one processor coupled to the display device; and
a storage device coupled to the at least one processor and storing one or more programs executable by the at least one processor to cause the at least one processor to:
receive a content of the message filtering template, after the first electronic device performing the function of filtering messages, the content of the message filtering template comprising functions to stop receiving messages from group members within a first certain period of time or refuse to send messages to one or more group members within a second certain period of time;
display an interface of a selection on a display device of the electronic device; and
send a selection made by the electronic device to the first electronic device through the server.

9. The electronic device according to claim 8, wherein the message filtering template comprises an event name of performing the function for filtering messages, a starting time of performing the function for filtering messages, an ending time of performing the function for filtering messages, whether the group messages appear or not after performing the function for filtering messages.

10. The electronic device according to claim 9, wherein when the function of filtering messages is set to stop receiving messages, the selection comprises “Confirm”; and when the function of filtering messages is set to refuse to send messages, the selection comprises “Confirm” or “Reject”.
